(19) United States
(12) Patent Application Publication
(10) Pub. No.: US 2013/0015937 A1
(43) Pub. Date: Jan. 17, 2013

(54) ELECTRONIC COMPONENT AND METHOD OF PRODUCING SAME

(71) Applicant: Atsushi SEKO, Kyoto-fu (JP)

(72) Inventor: Atsushi SEKO, Kyoto-fu (JP)

(73) Assignee: MURATA MANUFACTURING CO., LTD., Kyoto-fu (JP)

(21) Appl. No.: 13/545,378

(22) Filed: Jul. 10, 2012

(30) Foreign Application Priority Data
Jul. 11, 2011 (JP) 2011-152589

(51) Int. Cl. H01F 5/00; B05D 5/12

(52) U.S. Cl. 336/200; 427/97.3

(57) ABSTRACT

A laminate in which plural insulator layers are stacked includes an external electrode that is exposed to the exterior of the laminate and includes a plurality of conductive layers stacked in a staking direction and passing through some of the plural insulator layers in the stacking direction. At least one side of the external electrode facing in the stacking direction is overlaid with rest of the plural insulator layers. At least one side surface of the external electrode facing in the stacking direction is uneven with another portion of the side surface.

### CROSS REFERENCE TO RELATED APPLICATIONS

The present application claims priority from Japanese Patent Application No. 2011-152589 filed on Jul. 11, 2011, the entire contents of which are hereby incorporated by reference into this application.

### TECHNICAL FIELD

The technical field relates to an electronic component and a method of producing the same, and in particular, to an electronic component that includes a laminate and a method of producing the same.

### BACKGROUND

An example of a conventional electronic component is a stacked inductor described in Japanese Unexamined Patent Application Publication No. 2010-165975. FIG. 9 is an exploded perspective view of a stacked inductor 500 described in this patent literature.

As illustrated in FIG. 9, the stacked inductor 500 includes a laminate 502, external electrodes 508 and 510, and a coil L. The laminate 502 is one in which insulating layers 504a to 504d are stacked. The coil L is incorporated in the laminate 502 and includes coil conductive patterns 506a to 506c and via hole conductors V501 and V502. Each of the coil conductive patterns 506a to 506c has a substantially ring shape which is formed by cutting a part of a ring shape off. The coil conductive patterns 506a to 506c are disposed on the insulating layers 504b to 504d, respectively. The via hole conductor V501 connects the coil conductive patterns 506a and 506b. The via hole conductor V502 connects the coil conductive patterns 506b and 506c. Thus, the coil L has a substantially helical shape.

The external electrode 508 includes external electrode patterns 508a to 508c. Each of the external electrode patterns 508a to 508c has a substantially L shape. The external electrode patterns 508a to 508c are disposed in corners of the insulating layers 504b to 504d, respectively. The external electrode 510 includes external electrode patterns 510a to 510c. Each of the external electrode patterns 510a to 510c has a substantially L shape. The external electrode patterns 510a to 510c are disposed in corners of the insulating layers 504b to 504d, respectively. The top and bottom of the external electrodes 508 and 510 in the stacking direction thereof are overlaid with the insulating layers 504a and 504d, respectively.

### SUMMARY

The present disclosure provides an electronic component capable of suppressing the occurrence of breakage of a laminate and a method of producing the electronic component.

According to an aspect of the present disclosure, an electronic component includes a laminate in which plural insulator layers are stacked and an external electrode exposed to an exterior of the laminate includes plural conductive layers stacked in a staking direction. Each of the conductive layers pass through a first part of the plural insulator layers in a stacking direction. At least one side of the external electrode in the stacking direction is overlaid with a second part of the plural insulator layers. At least one side surface of the external electrode facing in the stacking direction includes a portion that is uneven with another portion of the side surface.

According to another aspect of the present invention, a method of producing an electronic component includes a first step of forming an outer insulator layer, a second step of forming, on the outer insulator layer, an inner insulator layer in which an opening is formed, a third step of forming a conductive layer on the inner insulator layer, the conductive layer having an area larger than the opening and overlapping the opening, and a fourth step of cutting a mother laminate including the outer insulator layer and the inner insulator layer into a plurality of laminates. In the fourth step an external electrode including the conductive layer is exposed from the laminate in a first cut surface formed by the cutting.

Other features, elements, characteristics, and advantages of the present disclosure will become more apparent from the following detailed description with reference to the attached drawings.

### BRIEF DESCRIPTION OF THE DRAWINGS

FIG. 1 is a perspective view of an electronic component according to a first exemplary embodiment.

FIG. 2 is an exploded perspective view of the electronic component illustrated in FIG. 1.

FIG. 3A illustrates the electronic component in plan view from a negative z-axis direction, FIG. 3B illustrates the electronic component in plan view from a negative x-axis direction, and FIG. 3C illustrates the electronic component in plan view from a positive x-axis direction.

FIGS. 4A to 4D are plan views of the electronic component in production.

FIGS. 5A to 5D are plan views of the electronic component in production.

FIGS. 6A to 6D are plan views of the electronic component in production.

FIGS. 7A to 7C are plan views of the electronic component in production.

FIG. 8A illustrates an electronic component in plan view from the negative z-axis direction, FIG. 8B illustrates the electronic component in plan view from the negative x-axis direction, and FIG. 8C illustrates the electronic component in plan view from the positive x-axis direction.

FIG. 9 is an exploded perspective view of a stacked inductor described in the related art.

### DETAILED DESCRIPTION

The inventor realized that in the stacked inductor 500 described in Japanese Unexamined Patent Application Publication No. 2010-165975, the laminate 502 may be damaged. More specifically, the process of producing the stacked inductor 500 contains a dividing step of dividing a mother laminate into individual laminates 502 and a firing step of firing the laminates 502. In the dividing step and the firing step, a stress is applied to each of the laminates 502. Because the material of the laminate 502 differs from the material of the external electrodes 508 and 510, when a stress is applied to the laminate 502, an internal stress remains between the laminate 502 and the external electrodes 508 and 510. If the laminate 502 is subjected to barrel polishing or plating in the state where the internal stress remains, the impact of the barrel polishing or plating may cause breakage such as a crack or the like in a portion in each of the insulating layers 504a and 504d, the portion being in contact with the external electrodes 508 and 510.

An electronic component according to exemplary embodiments and a method of producing the same that can address the above-described breakage issues will now be described.

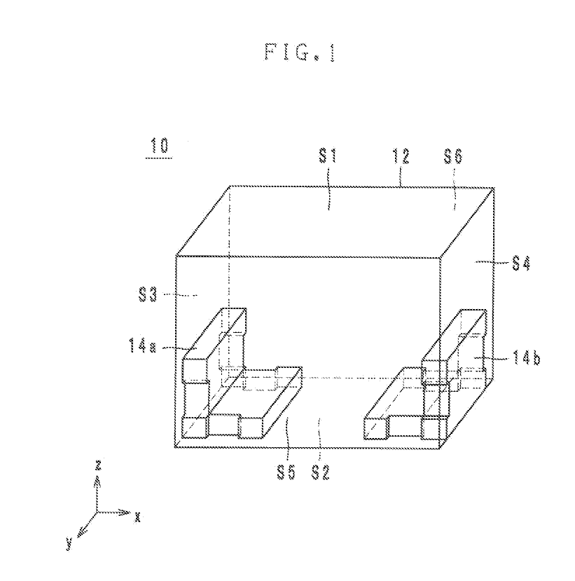

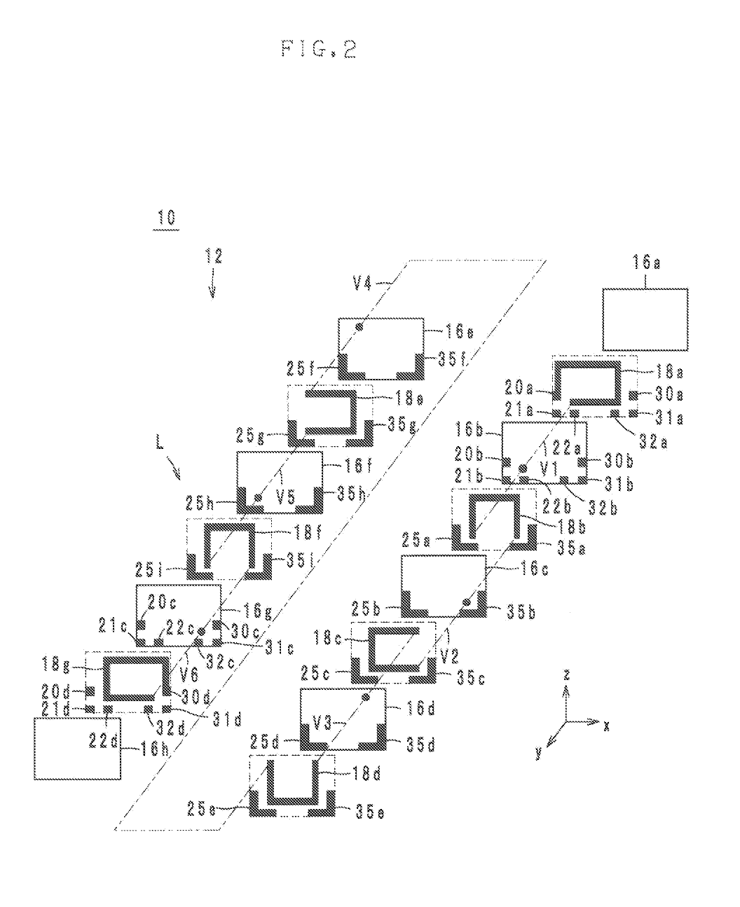

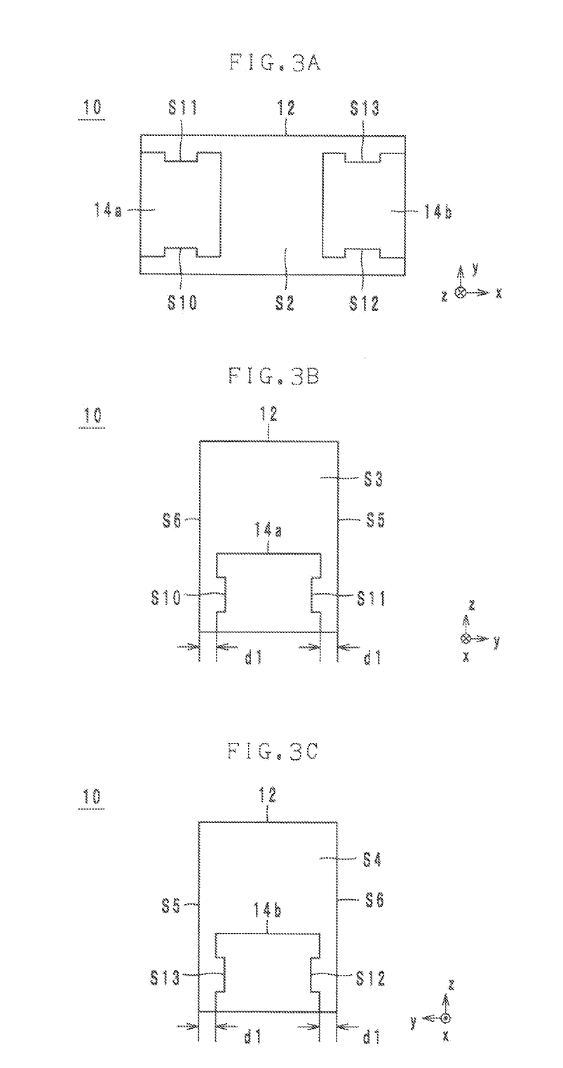

A configuration of an electronic component according to an exemplary embodiment is described below with reference to the drawings. FIG. 1 is a perspective view of an electronic component 10 according to a first exemplary embodiment. FIG. 2 is an exploded perspective view of the electronic component 10 illustrated in FIG. 1. In the following description, the stacking direction of the electronic component 10 is defined as the y-axis direction. In plan view from the y-axis direction, the direction in which the long sides of the electronic component 10 extend is defined as the x-axis direction and the direction in which the short sides of the electronic component 10 extend is defined as the z-axis direction. FIG. 3A illustrates the electronic component 10 in plan view from the negative z-axis direction, FIG. 3B illustrates the electronic component 10 in plan view from the negative x-axis direction, and FIG. 3C illustrates the electronic component 10 in plan view from the positive x-axis direction.

As illustrated in FIGS. 1 and 2, the electronic component 10 includes a laminate 12, external electrodes 14 (14a, 14b), and a coil L (not illustrated in FIG. 1).

As illustrated in FIG. 2, the laminate 12 is one in which a plurality of insulator layers 16 (16a to 16h) are stacked in this order from negative to positive in the y-axis direction. The laminate 12 has a substantially rectangular parallelepiped shape. The laminate 12 includes an upper surface S1, a lower surface S2, end surfaces S3 and S4, and side surfaces S5 and S6. The upper surface S1 is the surface of the laminate 12 in the positive z-axis direction. The lower surface S2 is the surface of the laminate 12 in the negative z-axis direction and a mounting surface that faces a circuit substrate when the electronic component 10 is mounted on the circuit substrate. The upper surface S1 is a series of the long sides (outer edges) of the insulator layers 16 facing in the positive z-axis direction, and the lower surface S2 is a series of the long sides (outer edges) of the insulator layers 16 facing in the negative z-axis direction. The end surface S3 is the surface of the laminate 12 facing in the negative x-axis direction, and the end surface S4 is the surface of the laminate 12 facing in the positive x-axis direction. The end surface S3 is a series of the short sides (outer edges) of the insulator layers 16 facing in the negative x-axis direction, and the end surface S4 is a series of the short sides (outer edges) of the insulator layers 16 facing in the positive x-axis direction. The end surfaces S3 and S4 are adjacent surfaces to the lower surface S2. The side surface S5 is the surface of the laminate 12 facing in the positive y-axis direction, and the side surface S6 is the surface of the laminate 12 facing in the negative y-axis direction.

As illustrated in FIG. 2, each of the insulator layers 16 can have a substantially rectangular shape and can be made of an insulating material whose main component is a borosilicate glass, for example. In the following description, the surface of the insulator layer 16 facing in the positive y-axis direction is referred to as a front surface, and the surface of the insulator layer 16 facing in the negative y-axis direction is referred to as a back surface.

The coil L includes coil conductive layers 18 (18a to 18g) and via hole conductors V1 to V6. The coil L has a substantially helical shape turning clockwise in plan view from the positive y-axis direction and winding from negative to positive in the y-axis direction. The coil conductive layers 18a to 18g are disposed on the insulator layers 16a to 16g, respectively. Each of the coil conductive layers 18a to 18g has a substantially rectangular ring shape which is formed by cutting off (i.e., excluding) a part of a rectangular ring shape. The number of turns of each of the coil conductive layers 18a to 18g is about ¾. Each of the coil conductive layers 18 can be made of a conductive material whose main component is silver, for example. In the following description, the upstream end in the clockwise direction of each coil conductive layer 18 is referred to as an upstream end, and the downstream end in the clockwise direction of each coil conductive layer 18 is referred to as a downstream end.

The via hole conductors V1 to V6 pass through the insulator layers 16b to 16g in the y-axis direction, respectively. The via hole conductors V1 to V6 can be made of a conductive material whose main component is silver, for example. The via hole conductor V1 connects the downstream end of the coil conductive layer 18a and the upstream end of the coil conductive layer 18b. The via hole conductor V2 connects the downstream end of the coil conductive layer 18b and the upstream end of the coil conductive layer 18c. The via hole conductor V3 connects the downstream end of the coil conductive layer 18c and the upstream end of the coil conductive layer 18d. The via hole conductor V4 connects the downstream end of the coil conductive layer 18d and the upstream end of the coil conductive layer 18e. The via hole conductor V5 connects the downstream end of the coil conductive layer 18e and the upstream end of the coil conductive layer 18f. The via hole conductor V6 connects the downstream end of the coil conductive layer 18f and the upstream end of the coil conductive layer 18g.

As illustrated in FIG. 1, the external electrode 14a is embedded in the laminate 12 and is exposed to the exterior of the laminate 12 so as to extend over the border between the end surface S3 and the lower surface S2. That is, in plan view from the y-axis direction, the external electrode 14a is substantially L-shaped. As illustrated in FIG. 2, the external electrode 14a is one in which external electrode conductive layers 20 (20a to 20d), 21 (21a to 21d), (22a to 22d), and 25 (25a to 25i) are stacked. The external electrode conductive layers 20 (20a to 20d), 21 (21a to 21d), 22 (22a to 22d), and 25 (25a to 25i) are stacked, thus passing through the insulator layers 16b to 16g in the y-axis direction and being electrically coupled together, as illustrated in FIG. 2.

The external electrode conductive layers 25b, 25d, 25f, and 25h pass through the insulator layers 16c, 16d, 16e, and 16f, respectively, in the y-axis direction and are substantially L-shaped. In plan view from the y-axis direction, the external electrode conductive layers 25b, 25d, 25f, and 25h are in contact with the short side of each of the insulator layers 16a and 16h in the negative x-axis direction and the long side thereof in the negative z-axis direction.

The external electrode conductive layers 25a to 25i coincide with each other in plan view from the y-axis direction. The external electrode conductive layer 25b is in contact with the external electrode conductive layers 25a and 25c. The external electrode conductive layer 25d is in contact with the external electrode conductive layers 25c and 25e. The external electrode conductive layer 25f is in contact with the external electrode conductive layers 25e and 25g. The external electrode conductive layer 25h is in contact with the external electrode conductive layers 25g and 25i.

The external electrode conductive layers 20a, 21a, and 22a are disposed on the front surface of the insulator layer 16a and are substantially rectangular. The external electrode conductive layers 20a, 21a, and 22a have a shape different from the shape of each of the external electrode conductive layers 25a to 25i in plan view from the y-axis direction and overlap the external electrode conductive layers 25a to 25i in plan view from the y-axis direction. More specifically, the external electrode conductive layer 21a is disposed in the corner of the insulator layer 16a in the negative x-axis direction and in the negative z-axis direction. The external electrode conductive layer 20a is disposed on the positive z-axis direction side with respect to the external electrode conductive layer 21a and is in contact with the short side of the insulator layer 16a in the negative x-axis direction. The external electrode conductive layer 20a is connected to the upstream end of the coil conductive layer 18a. The external electrode conductive layer 22a is disposed on the positive x-axis direction side with respect to the external electrode conductive layer 21a and is in contact with the long side of the insulator layer 16a in the negative z-axis direction.

The external electrode conductive layers 20b, 21b, and 22b pass through the insulator layer 16b in the y-axis direction and coincide with the external electrode conductive layers 20a, 21a, and 22a, respectively, in plan view from the y-axis direction. The external electrode conductive layers 20b, 21b, and 22b are in contact with the external electrode conductive layers 20a, 21a, and 22a, respectively.

The external electrode conductive layers 20c, 21c, and 22c pass through the insulator layer 16g in the y-axis direction and coincide with the external electrode conductive layers 20a, 21a, and 22a, respectively, in plan view from the y-axis direction.

The external electrode conductive layers 20d, 21d, and 22d coincide with the external electrode conductive layers 20c, 21c, and 22c, respectively, in plan view from the y-axis direction. The external electrode conductive layers 20d, 21d, and 22d are in contact with the external electrode conductive layers 20c, 21c, and 22c, respectively.

In the external electrode 14a, in which the external electrode conductive layers 20, 21, 22, and 25 are stacked in the above-described way, a side surface S10 of the external electrode 14a located at the end in the negative y-axis direction and a side surface S11 of the external electrode 14a located at the end in the positive y-axis direction are uneven, as illustrated in FIGS. 3A and 3B.

More specifically, the side surface S10 is defined by the external electrode conductive layers 20a, 20b, 21a, 21b, 22a, 22b, and 25a. The external electrode conductive layers 20a, 20b, 21a, 21b, 22a, and 22b protrude in the negative y-axis direction farther than the external electrode conductive layer 25a. Thus, the side surface S10 has a shape in which in plan view from the negative z-axis direction both ends thereof in the x-axis direction protrude in the negative y-axis direction and a substantially central portion thereof in the x-axis direction is depressed in the positive y-axis direction. The side surface S10 also has a shape in which in plan view from the negative x-axis direction both ends thereof in the z-axis direction protrude in the negative y-axis direction and a substantially central portion thereof in the z-axis direction is depressed in the positive y-axis direction.

The side surface S11 is defined by the external electrode conductive layers 20c, 20d, 21c, 21d, 22c, 22d, and 25i. The external electrode conductive layers 20c, 20d, 21c, 21d, 22c, and 22d protrude in the positive y-axis direction farther than the external electrode conductive layer 25i. The side surface S11 has a shape in which in plan view from the negative z-axis direction both ends thereof in the x-axis direction protrude in the positive y-axis direction and a substantially central portion thereof in the x-axis direction is depressed in the negative y-axis direction. The side surface S11 also has a shape in which in plan view from the negative x-axis direction both ends thereof in the z-axis direction protrude in the positive y-axis direction and a substantially central portion thereof in the z-axis direction is depressed in the negative y-axis direction.

As illustrated in FIG. 1, the external electrode 14b is embedded in the laminate 12 and is exposed to the exterior of the laminate 12 so as to extend over the border between the end surface S4 and the lower surface S2. That is, in plan view from the y-axis direction, the external electrode 14b is substantially L-shaped. As illustrated in FIG. 2, the external electrode 14b is one in which external electrode conductive layers 30 (30a to 30d), 31 (31a to 31d), (32a to 32d), and 35 (35a to 35i) are stacked. The external electrode conductive layers 30 (30a to 30d), 31 (31a to 31d), 32 (32a to 32d), and 35 (35a to 35i) are stacked, thus passing through part of the insulator layers 16 (the insulator layers 16b to 16g) in the y-axis direction and being electrically coupled together, as illustrated in FIG. 2.

The external electrode conductive layers 35b, 35d, 35f, and 35h pass through the insulator layers 16c, 16d, 16e, and 16f, respectively, in the y-axis direction and are substantially L-shaped. In plan view from the y-axis direction, the external electrode conductive layers 35b, 35d, 35f, and 35h are in contact with the short side of each of the insulator layers 16a and 16h (rest of the insulator layers 16) in the positive x-axis direction and the long side thereof in the negative z-axis direction.

The external electrode conductive layers 35a to 35i coincide with each other in plan view from the y-axis direction. The external electrode conductive layer 35b is in contact with the external electrode conductive layers 35a and 35c. The external electrode conductive layer 35d is in contact with the external electrode conductive layers 35c and 35e. The external electrode conductive layer 35f is in contact with the external electrode conductive layers 35e and 35g. The external electrode conductive layer 35h is in contact with the external electrode conductive layers 35g and 35i.

The external electrode conductive layers 30a, 31a, and 32a are disposed on the front surface of the insulator layer 16a and are substantially rectangular. The external electrode conductive layers 30a, 31a, and 32a have a shape different from the shape of each of the external electrode conductive layers 35a to 35i in plan view from the y-axis direction and overlap the external electrode conductive layers 35a to 35i in plan view from the y-axis direction. More specifically, the external electrode conductive layer 31a is disposed in the corner of the insulator layer 16a in the positive x-axis direction and in the negative z-axis direction. The external electrode conductive layer 30a is disposed on the positive z-axis direction side with respect to the external electrode conductive layer 31a and is in contact with the short side of the insulator layer 16a in the positive x-axis direction. The external electrode conductive layer 32a is disposed on the negative x-axis direction side with respect to the external electrode conductive layer 31a and is in contact with the long side of the insulator layer 16a in the negative z-axis direction.

The external electrode conductive layers 30b, 31b, and 32b pass through the insulator layer 16b in the y-axis direction and coincide with the external electrode conductive layers 30a, 31a, and 32a, respectively, in plan view from the y-axis direction. The external electrode conductive layers 30b, 31b, and 32b are in contact with the external electrode conductive layers 30a, 31a, and 32a, respectively.

The external electrode conductive layers 30c, 31c, and 32c pass through the insulator layer 16g in the y-axis direction and coincide with the external electrode conductive layers 30a, 31a, and 32a, respectively, in plan view from the y-axis direction.

The external electrode conductive layers 30d, 31d, and 32d coincide with the external electrode conductive layers 30c, 31c, and 32c, respectively, in plan view from the y-axis direction. The external electrode conductive layers 30d, 31d, and 32d are in contact with the external electrode conductive layers 30c, 31c, and 32c, respectively. The external electrode conductive layer 30d is connected to the downstream end of the coil conductive layer 18g.

The external electrode conductive layers 30, 31, 32, and 35 are stacked in the above-described way, whereby a side surface S12 of the external electrode 14b located at the end in the negative y-axis direction and a side surface S13 of the external electrode 14b located at the end in the positive y-axis direction are uneven, as illustrated in FIGS. 3A and 3C.

More specifically, the side surface S12 is defined by the external electrode conductive layers 30a, 30b, 31a, 31b, 32a, 32b, and 35a. The external electrode conductive layers 30a, 30b, 31a, 31b, 32a, and 32b protrude in the negative y-axis direction farther than the external electrode conductive layer 35a. The side surface S12 has a shape in which in plan view from the negative z-axis direction both ends thereof in the x-axis direction protrude in the negative y-axis direction and a substantially central portion thereof in the x-axis direction is depressed in the positive y-axis direction. The side surface S12 also has a shape in which in plan view from the positive x-axis direction both ends thereof in the z-axis direction protrude in the negative y-axis direction and a substantially central portion thereof in the z-axis direction is depressed in the positive y-axis direction.

The side surface S13 is defined by the external electrode conductive layers 30c, 30d, 31c, 31d, 32c, 32d, and 35i. The external electrode conductive layers 30c, 30d, 31c, 31d, 32c, and 32d protrude in the positive y-axis direction farther than the external electrode conductive layer 35i. The side surface S13 has a shape in which in plan view from the negative z-axis direction both ends thereof in the x-axis direction protrude in the positive y-axis direction and a substantially central portion thereof in the x-axis direction is depressed in the negative y-axis direction. The side surface S13 also has a shape in which in plan view from the positive x-axis direction both ends thereof in the z-axis direction protrude in the positive y-axis direction and a substantially central portion thereof in the z-axis direction is depressed in the negative y-axis direction.

The portion of each of the external electrodes 14a and 14b exposed from the laminate 12 to the outside is subjected to nickel plating and tin plating and to prevent corrosion.

Each of both sides of the each of the external electrodes 14a and 14b in the y-axis direction is overlaid with the insulator layer 16a or 16h. Thus, the external electrodes 14a and 14b are not exposed in the side surfaces S5 and S6.

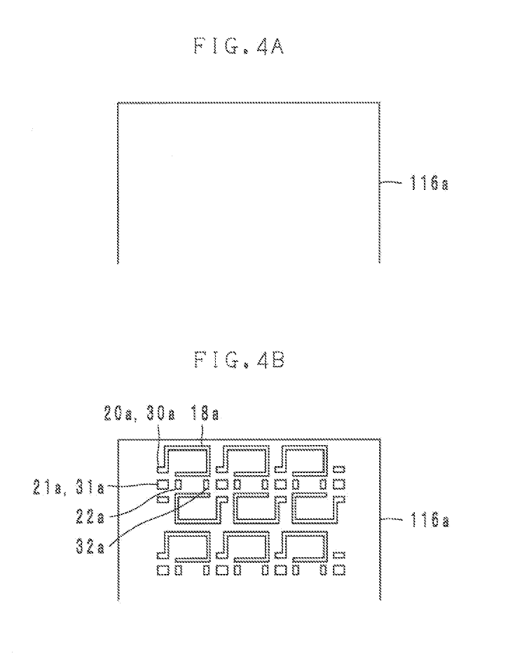

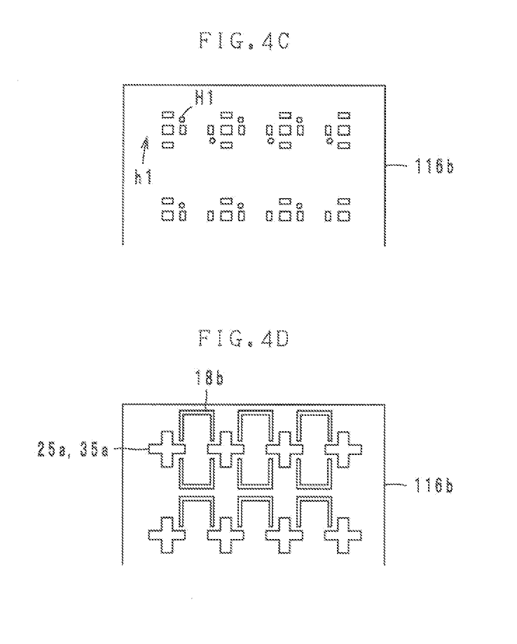

A method of producing the electronic component 10 according to the first exemplary embodiment will now be described with reference to the drawings. FIGS. 4A to 7C are plan views of the electronic component 10 in production.

First, as illustrated in FIG. 4A, insulating paste whose main component is a borosilicate glass is applied by screen printing to form an insulating paste layer 116a. The insulating paste layer 116a is a paste layer that is to become the insulator layer 16a, which is an outer insulator layer located outside the coil L.

Next, as illustrated in FIG. 4B, the coil conductive layers 18a and the external electrode conductive layers 20a, 21a, 22a, 30a, 31a, and 32a are formed by a photolithography step. Specifically, photosensitive conductive paste whose metal main component is silver is applied by screen printing to form a photosensitive conductive paste layer on the insulating paste layer 116a. In addition, the photosensitive conductive paste layer is irradiated with ultraviolet rays or other rays through a photomask and developed using an alkaline solution or other solution.

Then, as illustrated in FIG. 4C, an insulating paste layer 116b having a plurality of opening group h1 and via holes H1 is formed by a photolithography step. Specifically, insulating paste is applied by screen printing to from an insulating paste layer on the insulating paste layer 116a. In addition, the photosensitive conductive paste layer is irradiated with ultraviolet rays or other rays through a photomask and developed using an alkaline solution or other solution. The insulating paste layer 116b is a paste layer that is to become the insulator layer 16b, which is an inner insulator layer on which the coil L is disposed. Each of the opening group h1 has substantially the same shape as that of set of the external electrode conductive layers 20a, 21a, 22a, 30a, 31a, and 32a and overlaps the external electrode conductive layers 20a, 21a, 22a, 30a, 31a, and 32a.

Then, as illustrated in FIG. 4D, the coil conductive layers 18b, the external electrode conductive layers 20b, 21b, 22b, 30b, 31b, 32b, 25a, and 35a, and the via hole conductors V1 are formed by a photolithography step. Specifically, photosensitive conductive paste whose metal main component is silver is applied by screen printing to form a photosensitive conductive paste layer on the insulating paste layer 116b. In addition, the photosensitive conductive paste layer is irradiated with ultraviolet rays or other rays through a photomask and developed using an alkaline solution or other solution. In the step, the conductive layers are formed on the insulating paste layer 116b so as to have an area larger than corresponding opening group h1 and overlap the corresponding opening group h1. In this way, the external electrode conductive layers 20b, 21b, 22b, 30b, 31b, and 32bare formed in the opening group h1. The via hole conductors V1 are formed in the via holes H1. In FIG. 4D, the external electrode conductive layers 20b, 21b, 22b, 30b, 31b, and 32b and the via hole conductors V1 are not illustrated because they are hidden by the coil conductive layer 18b and the external electrode conductive layers 25a and 35a.

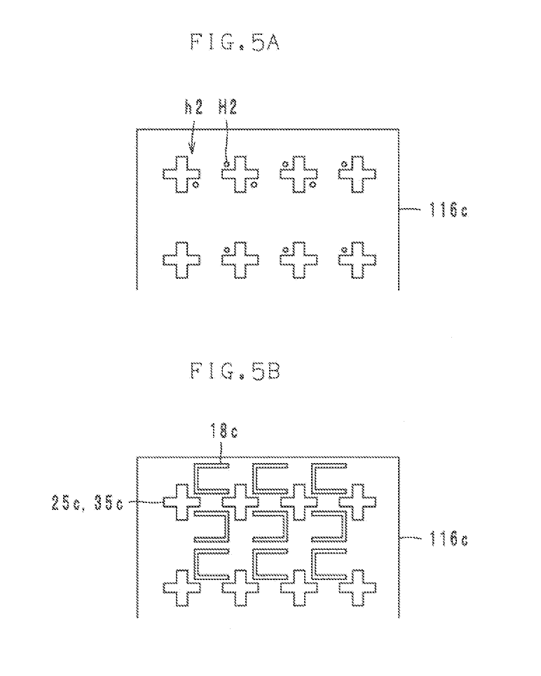

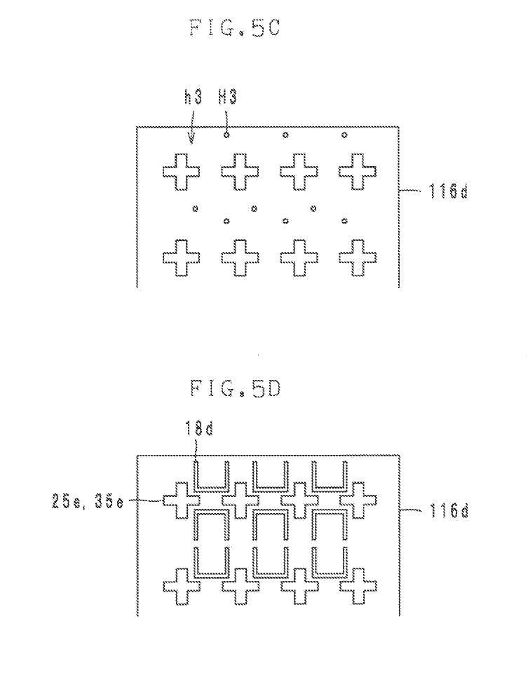

Then, as illustrated in FIG. 5A, an insulating paste layer 116c having openings h2 and via holes H2 is formed by a photolithography step. Specifically, insulating paste is applied by screen printing to form an insulating paste layer on the insulating paste layer 116b. In addition, the photosensitive conductive paste layer is irradiated with ultraviolet rays or other rays through a photomask and developed using an alkaline solution or other solution. The insulating paste layer 116c is a paste layer that is to become the insulator layer 16c, which is an internal insulator layer. Each of the openings h2 has a cross shape in which the two external electrode conductive layers 25b and the two external electrode conductive layers 35b are combined.

Then, as illustrated in FIG. 5B, the coil conductive layers 18c, the external electrode conductive layers 25b, 25c, 35b, and 35c, and the via hole conductors V2 are formed by a photolithography step. Specifically, photosensitive conductive paste whose main metal component is silver is applied by screen printing to form a photosensitive conductive paste layer on the insulating paste layer 116c. In addition, the photosensitive conductive paste layer is irradiated with ultraviolet rays or other rays through a photomask and developed using an alkaline solution or other solution. In this way, the external electrode conductive layers 25b and 35b are formed in the openings h2. The via hole conductors V2 are formed in the via holes H2. In FIG. 5B, the external electrode conductive layers 25b and 35b and the via hole conductors V2 are not illustrated because they are hidden by the coil conductive layers 18c and the external electrode conductive layers 25c and 35c.

Then, as illustrated in FIG. 5C, an insulating paste layer 116d having openings h3 and via holes H3 is formed by a photolithography step. Specifically, insulating paste is applied by screen printing to from an insulating paste layer on the insulating paste layer 116c. In addition, the photosensitive conductive paste layer is irradiated with ultraviolet rays or other rays through a photomask and developed using an alkaline solution or other solution. The insulating paste layer 116d is a paste layer that is to become the insulator layer 16d, which is an inner insulator layer. Each of the openings h3 has substantially the same shape as that of each of the openings h2.

Then, as illustrated in FIG. 5D, the coil conductive layers 18d, the external electrode conductive layers 25d, 25e, 35d, and 35e, and the via hole conductors V3 are formed by a photolithography step. Specifically, photosensitive conductive paste whose metal main component is silver is applied by screen printing to form a photosensitive conductive paste layer on the insulating paste layer 116d. In addition, the photosensitive conductive paste layer is irradiated with ultraviolet rays or other rays through a photomask and developed using an alkaline solution or other solution. In this way, the external electrode conductive layers 25d and 35d are formed in the openings h3. The via hole conductors V3 are formed in the via holes H3. In FIG. 5D, the external electrode conductive layers 25d and 35d and the via hole conductors V3 are not illustrated because they are hidden by the coil conductive layers 18d and the external electrode conductive layers 25e and 35e.

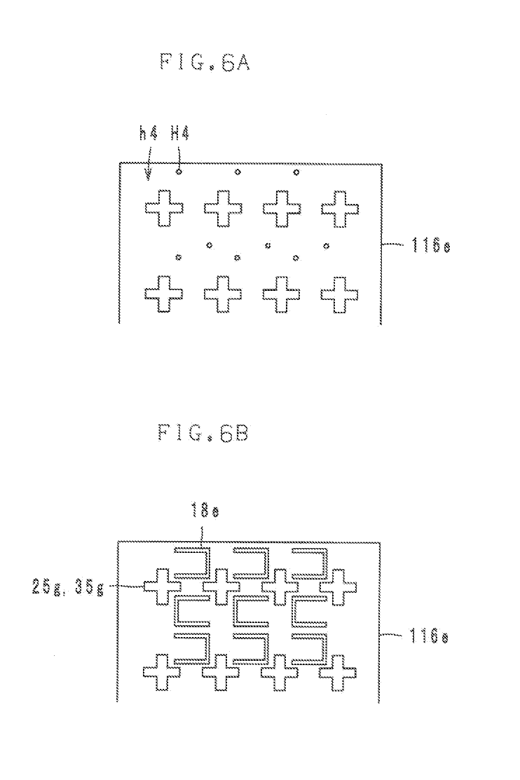

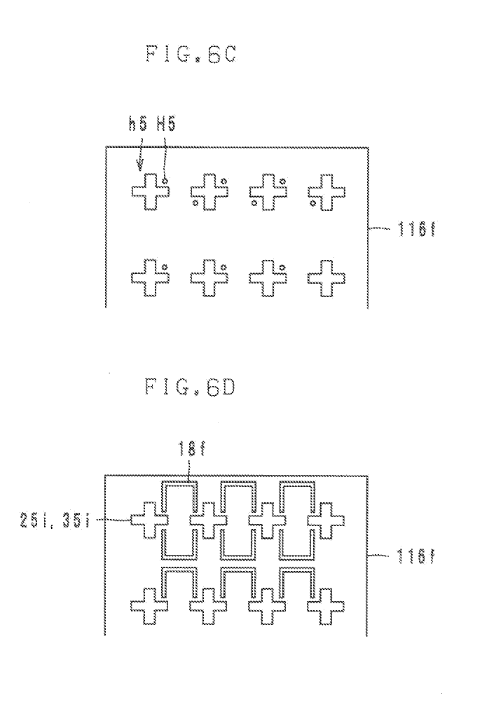

Then, as illustrated in FIG. 6A, an insulating paste layer 116e having openings h4 and via holes H4 is formed by a photolithography step. Specifically, insulating paste is applied by screen printing to form an insulating paste layer on the insulating paste layer 116d. In addition, the photosensitive conductive paste layer is irradiated with ultraviolet rays or other rays through a photomask and developed using an alkaline solution or other solution. The insulating paste layer 116e is a paste layer that is to become the insulator layer 16e, which is an internal insulator layer. Each of the openings h4 has substantially the same shape as that of each of the openings h2.

Then, as illustrated in FIG. 6B, the coil conductive layers 18e, the external electrode conductive layers 25f, 25g, 35f, and 35g, and the via hole conductors V4 are formed by a photolithography step. Specifically, photosensitive conductive paste whose main metal component is silver is applied by screen printing to form a photosensitive conductive paste layer on the insulating paste layer 116e. In addition, the photosensitive conductive paste layer is irradiated with ultraviolet rays or other rays through a photomask and developed using an alkaline solution or other solution. In this way, the external electrode conductive layers 25f and 35f are formed in the openings h4. The via hole conductors V4 are formed in the via holes H4. In FIG. 6B, the external electrode conductive layers 25f and 35f and the via hole conductors V4 are not illustrated because they are hidden by the coil conductive layers 18e and the external electrode conductive layers 25g and 35g.

Then, as illustrated in FIG. 6C, an insulating paste layer 116f having openings h5 and via holes H5 is formed by a photolithography step. Specifically, insulating paste is applied by screen printing to from an insulating paste layer on the insulating paste layer 116e. In addition, the photosensitive conductive paste layer is irradiated with ultraviolet rays or other rays through a photomask and developed using an alkaline solution or other solution. The insulating paste layer 116f is a paste layer that is to become the insulator layer 16f, which is an inner insulator layer. Each of the openings h5 has substantially the same shape as that of each of the openings h2.

Then, as illustrated in FIG. 6D, the coil conductive layers 18f, the external electrode conductive layers 25h, 25i, 35h, and 35i and the via hole conductors V5 are formed by a photolithography step. Specifically, photosensitive conductive paste whose metal main component is silver is applied by screen printing to form a photosensitive conductive paste layer on the insulating paste layer 116f. In addition, the photosensitive conductive paste layer is irradiated with ultraviolet rays or other rays through a photomask and developed using an alkaline solution or other solution. In this way, the external electrode conductive layers 25h and 35h are formed in the openings h5. The via hole conductors V5 are formed in the via holes H5. In FIG. 6D, the external electrode conductive layers 25h and 35h and the via hole conductors V5 are not illustrated because they are hidden by the coil conductive layers 18f and the external electrode conductive layers 25i and 35i.

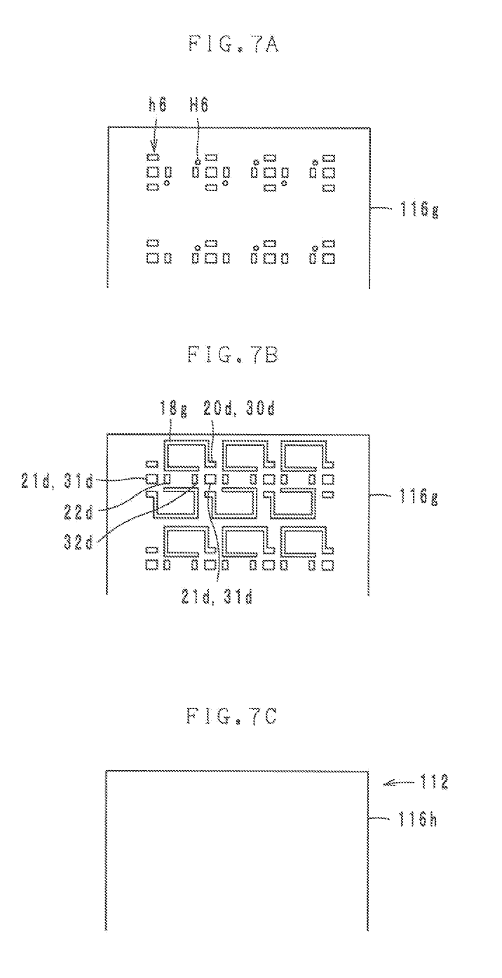

Then, as illustrated in FIG. 7A, an insulating paste layer 116g having a plurality of opening group h6 and via holes H6 is formed by a photolithography step. Specifically, insulating paste is applied by screen printing to form an insulating paste layer on the insulating paste layer 116f. In addition, the photosensitive conductive paste layer is irradiated with ultraviolet rays or other rays through a photomask and developed using an alkaline solution or other solution. The insulating paste layer 116g is a paste layer that is to become the insulator layer 16g, which is an internal insulator layer. Each of the opening group h6 has substantially the same shape as that of set of the external electrode conductive layers 20d, 21d, 22d, 30d, 31d, and 32d and overlaps the external electrode conductive layers 20d, 21d, 22d, 30d, 31d, and 32d.

Then, as illustrated in FIG. 7B, the coil conductive layers 18g and the external electrode conductive layers 20c, 20d, 21c, 21d, 22c, 22d, 30c, 30d, 31c, 31d, 32c, and 32d and the via hole conductors V6 are formed by a photolithography step. Specifically, photosensitive conductive paste whose metal main component is silver is applied by screen printing to form a photosensitive conductive paste layer on the insulating paste layer 116g. In addition, the photosensitive conductive paste layer is irradiated with ultraviolet rays or other rays through a photomask and developed using an alkaline solution or other solution. In this way, the external electrode conductive layers 20c, 21c, 22c, 30c, 31c, and 32c are formed in the openings h6. The via hole conductors V6 are formed in the via holes H6. In FIG. 7B, the external electrode conductive layers 20c, 21c, 22c, 30c, 31c, and 32c and the via hole conductors V6 are not illustrated because they are hidden by the coil conductive layers 18g and the external electrode conductive layers 21d, 22d, 30d, and 31d.

Then, as illustrated in FIG. 7C, an insulating paste layer 116h is formed on the insulating paste layer 116g by application of insulating paste by screen printing. The insulating paste layer 116g is a paste layer that is to become the insulator layer 16h, which is an outer insulator layer. Through the above-described steps, a mother laminate 112 is obtained.

Then, the mother laminate 112 is cut into a plurality of unfired laminates 12 by, for example, dicing. In the step of cutting the mother laminate 112, each of the external electrodes 14a and 14b is made to be exposed from each of the laminates 12 in two neighboring cut surfaces formed by the cutting. The two neighboring cut surfaces for the external electrode 14a are the lower surface S2 and the end surface S3, whereas those for the external electrode 14b are the lower surface S2 and the end surface S4.

Then, the unfired laminate 12 is fired under a predetermined condition, and the fired laminate 12 is obtained. In addition, the laminate 12 is subjected to barreling.

Lastly, the portions in the external electrodes 14a and 14b exposed from the laminate 12 are subjected to nickel plating with a thickness of approximately 2 μm to 7 μm and tin plating with a thickness of approximately 2 μm to 7 μm. Through the above-described steps, the electronic component 10 is completed.

In the electronic component 10 configured in the above-described way, the occurrence of breakage of the laminate 12 can be suppressed. More specifically, the process of producing the stacked inductor 500 described in Japanese Unexamined Patent Application Publication No. 2010-165975 contains a dividing step of dividing a mother laminate into individual laminates 502 and a firing step of firing the laminates 502. In the dividing step and the firing step, a stress is applied to each of the laminates 502. Because the material of the laminate 502 differs from the material of the external electrodes 508 and 510, when a stress is applied to the laminate 502, an internal stress remains between the laminate 502 and the external electrodes 508 and 510. If the laminate 502 is subjected to barrel polishing or plating in the state where the internal stress remains, the impact of the barrel polishing or plating may cause in a portion in each of the insulating layers 504a and 504d, the portion being in contact with the external electrodes 508 and 510. As the result, breakage such as a crack or the like is caused in the portion therein.

In contrast, in the electronic component 10, the side surfaces S10 to S13 located on both sides of the external electrodes 14a and 14b in the y-axis direction are uneven. Therefore, the area in which the insulator layers 16a and 16h on both sides of the external electrodes 14a and 14b in the y-axis direction are in contact with the external electrodes 14a and 14b is increased, whereby the adhesion therebetween is high. As a result, even if an impact occurs in the laminate 12, the occurrence of breakage such as a crack in the portions of the insulator layers 16a and 16h in contact with the external electrodes 14a and 14b is suppressed. That is, breakage of the electronic component 10 is suppressed.

In the electronic component 10 of the preferred embodiments, both sides of the external electrodes 14a and 14b in the y-axis direction is overlaid with the insulator layers 16a and 16h. However, it is not restrictive and it is possible to change to only one of the external electrodes being overlaid with insulator layer.

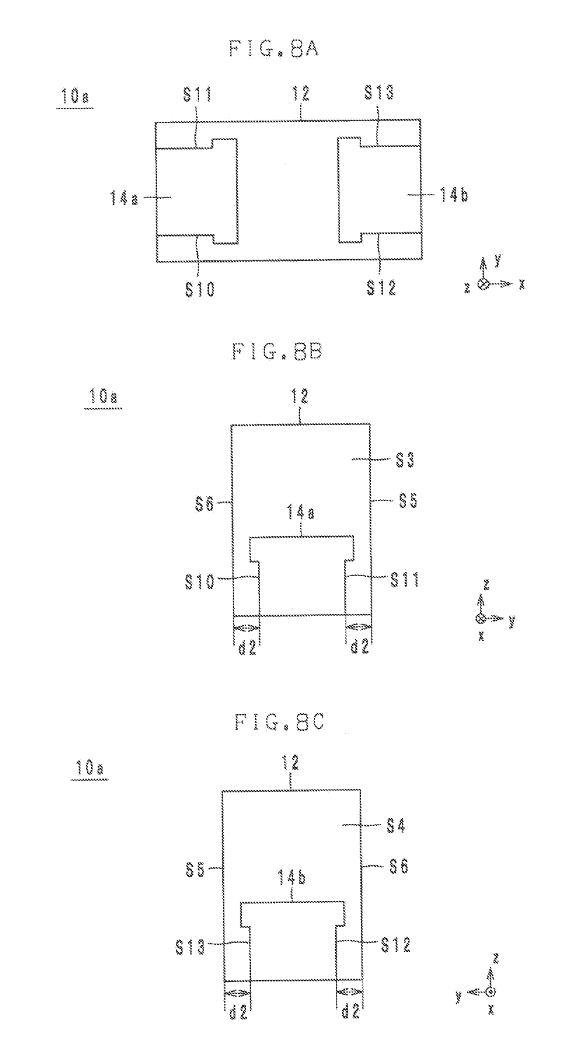

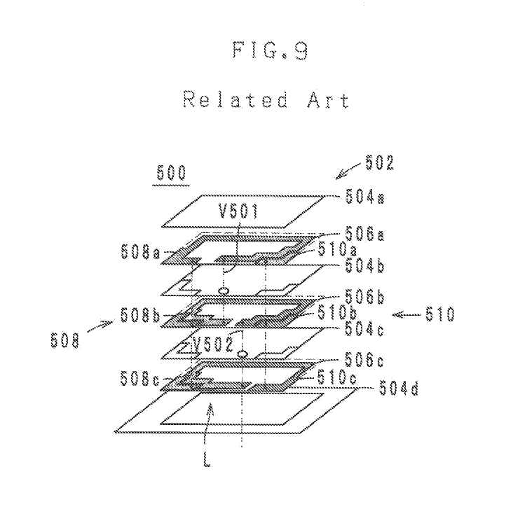

Next, an electronic component 10a according to a variation is described with reference to the drawings. FIG. 8A illustrates the electronic component 10a in plan view from the negative z-axis direction, FIG. 8B illustrates the electronic component 10a in plan view from the negative x-axis direction, and FIG. 8C illustrates the electronic component 10a in plan view from the positive x-axis direction.

The electronic component 10a differs from the electronic component 10 in the shape of each of the external electrodes 14a and 14b. The electronic component 10a does not include the external electrode conductive layers 21 and 31. Thus, the side surface S10 has a shape in which in plan view from the negative z-axis direction the end in the positive x-axis direction protrudes in the negative y-axis direction farther than the other portions. The side surface S10 also has a shape in which in plan view from the negative x-axis direction the end in the positive z-axis direction protrudes in the negative y-axis direction farther than the other portions.

Similarly, the side surface S11 has a shape in which in plan view from the negative z-axis direction the end in the positive x-axis direction protrudes in the positive y-axis direction farther than the other portions. The side surface S11 also has a shape in which in plan view from the negative x-axis direction the end in the positive z-axis direction protrudes in the positive y-axis direction farther than the other portions.

The side surface S12 has a shape in which in plan view from the negative z-axis direction, the end in the negative x-axis direction protrudes in the negative y-axis direction farther than the other portions. The side surface S12 also has a shape in which in plan view from the positive x-axis direction, the end in the positive z-axis direction protrudes in the negative y-axis direction farther than the other portions.

Similarly, the side surface S13 has a shape in which in plan view from the negative z-axis direction the end in the negative x-axis direction protrudes in the positive y-axis direction farther than the other portions. The side surface S13 also has a shape in which in plan view from the positive x-axis direction the end in the positive z-axis direction protrudes in the positive y-axis direction farther than the other portions.

In the above-described electronic component 10a, breakage of the laminate can be suppressed. More specifically, a corner of the laminate is easily broken by an impact from the outside. In the electronic component 10a, the width of the external electrode 14a in the y-axis direction is not a maximum in the corner between the lower surface S2 and the end surface S3, and the width of the external electrode 14b in the y-axis direction is not a maximum in the corner between the lower surface S2 and the end surface S4. Therefore, the distance d2 from each of the external electrodes 14a and 14b to each of the side surfaces S5 and S6 in the corner of the electronic component 10a is larger than the distance d1 from each of the external electrodes 14a and 14b to each of the side surfaces S5 and S6 in the corner of the electronic component 10. Accordingly, in the electronic component 10a, the occurrence of breakage in a corner of the laminate 12 can be suppressed.

To form the above-described external electrodes 14a and 14b, in the steps illustrated in FIGS. 4C and 7A, the insulating paste layers 116b and 116g are formed such that the openings h1 and h6 are not located in the corner between the two neighboring cut surfaces formed by cutting of the mother laminate 112. In addition, in the steps illustrated in FIGS. 4B and 7B, the external electrode conductive layers 21 and 31 are not formed.

In the electronic components 10 and 10a, all of the side surfaces S10 and S11 of the external electrode 14a and the side surfaces S12 and S13 of the external electrode 14b are uneven. However, suppression of lamination breakage can be achieved with at least one of the side surfaces S10 and S11 uneven and/or at least one of the side surfaces S12 and S13 uneven.

In the electronic components 10 and 10a, both sides of the external electrodes 14a and 14b in the y-axis direction is overlaid with the insulator layers 16a and 16h. However, these examples are not restrictive and it is possible to change them to only one of the external electrodes being overlaid with insulator layer.

As described above, preferred embodiments of the present invention are useful in an electronic component and a method of producing the same and, in particular, advantageous in that breakage of a laminate can be suppressed.

While exemplary embodiments have been described above, it is to be understood that variations and modifications will be apparent to those skilled in the art without departing from the scope and spirit of the disclosure.

What is claimed is:

1. An electronic component comprising:
a laminate in which plural insulator layers are stacked; and
an external electrode exposed to an exterior of the laminate and comprising plural conductive layers stacked in a stacking direction, each of said conductive layers passing through a first part of the plural insulator layers in the stacking direction,
wherein at least one side of the external electrode facing in the stacking direction is overlaid with a second part of the plural insulator layers, and
at least one side surface of the external electrode facing the stacking direction includes a portion that is uneven with another portion of the side surface.

2. The electronic component according to claim 1, wherein the laminate includes a mounting surface, the mounting surface being a series of outer edges of the plurality of insulator layers, and
the external electrode is exposed to the exterior of the laminate in the mounting surface.

3. The electronic component according to claim 2, wherein the external electrode is exposed to the exterior of the laminate so as to extend over a border between the mounting surface and an end surface, the end surface being adjacent to the mounting surface and being a series of outer edges of the plurality of insulator layers.

4. The electronic component according to claim 3, wherein the external electrode has a width in the stacking direction, the width not being a maximum in a corner between the mounting surface and the end surface.

5. The electronic component according to any one of claim 1, wherein the uneven side surface is located at at least one end thereof in the stacking direction, the uneven side surface being formed of the stacked conductive layers having different shapes in plan view from the stacking direction.

6. A method of producing an electronic component, the method comprising:
a first step of forming an outer insulator layer;
a second step of forming, on the outer insulator layer, an inner insulator layer in which an opening is formed;
a third step of forming a conductive layer on the inner insulator layer, the conductive layer having an area larger than the opening and overlapping the opening; and
a fourth step of cutting a mother laminate including the outer insulator layer and the inner insulator layer into a plurality of laminates,
wherein in the fourth step an external electrode including the conductive layer is exposed from the laminate in a first cut surface formed by the cutting.

7. The method of producing an electronic component according to claim 6, wherein in the fourth step the external electrode including the conductive layer is exposed from the laminate in a second cut surface, the second cut surface being formed by the cutting and adjacent to the first cut surface.

8. The method of producing an electronic component according to claim 6, wherein in the second step the inner insulator layer is formed such that the opening is not located in a corner between the first cut surface and the second cut surface.
